(19) United States
(12) Patent Application Publication
(10) Pub. No.: US 2004/0068436 A1
(43) Pub. Date: Apr. 8, 2004

(54) System and method for influencing position of information tags allowing access to on-site information

(76) Inventors: Brian J. Boubek, Phoenix, AZ (US); David Barnes, Anthem, AZ (US)

Correspondence Address: QUARLES & BRADY LLP, RENAISSANCE ONE, TWO NORTH CENTRAL AVENUE, PHOENIX, AZ, 85004-2391, US

(21) Appl. No.: 10/266,320

(22) Filed: Oct. 8, 2002

(51) Int. Cl. G06F 17/60

(52) U.S. Cl. 705/14

(57) ABSTRACT

A system and method for influencing position of information tags as displayed spatially or temporally is disclosed. The system and method allow information providers the ability to influence position of their information tags by auctioning directory search terms associated with the information tag, and then ranking the displaying the information tags based upon the information provider's bid amount from the auction. The information tags then allow consumers access to information maintained on the same web site as the information tag. The system and method allows targeting of specific markets and facilitates a novel method of marketing through a communication network, such as the Internet. The method also allows for novel management of web-based advertising accounts and budgeting of information provider funds.

### FIELD OF THE INVENTION

The present invention relates generally to a system and method for enabling an information provider to provide access to its information through a provider directory and more particularly to a system and method for bidding on and ranking identifying information tags, that when selected, charge the information provider its bid price to provide access to the information.

### BACKGROUND OF THE INVENTION

Ease of access to information and the transfer of that information over computer networks, especially over the Internet, has become an increasingly important way for businesses to solicit customers, and for customers to locate businesses to meet their needs. The Internet represents the most comprehensive worldwide marketplace which is driven by an information system known as the World Wide Web. The “Web” is a compilation of “web sites,” each comprising one or more “web pages” of information.

In locating information on the Internet, a user first accesses a web site with either a directory that allows the user to search information on that site, or more broadly, a search engine for locating information throughout the Internet. The user is normally prompted to enter a search term comprising one or more words. The respective directory for that web site or Internet search engine then generates a listing of results for that search term.

Traditional advertising paradigms have been used on internet web sites and on web pages. Banner advertising, where the owner of one web site sells space on one or more web pages, is frequently employed. This banner usually contains a link to the advertiser's website. The advertiser may pay one amount for displaying the banner and then an additional amount for every click-though referral to the advertiser's web site that is generated by the banner. Additionally, other types of click-through advertising are available for businesses to advertise and increase traffic on their own web site, while owners of popular web sites reap a financial benefit.

Finally, some web sites employ a bidding scheme where advertisers can bid on the placement of their link or the frequency in which the link is displayed when Internet users access a particular web site or web page. The more prevalent or visible, either in placement, size, or frequency of an advertisement, the more likely an end user will click-through to that advertiser's web site. This bidding scheme has been applied to determine “click-through” referral rates for each referral to the advertiser's own web site that is generated. The bidding scheme allows the advertiser to bid on search terms that the potential customer may use to find services on the Internet. The advertiser can then bid highest on search terms most directly related to their service.

However, several drawbacks exist in this current method. In order to advertise in this global marketplace, the advertiser must have its own web site. A potential customer cannot access any further information about the advertiser without “clicking through” to the advertiser's own web site. Normally, having a viable web site requires web site development, web site hosting, and web site maintenance, all resulting in additional cost and liability of advertising on the Internet.

Furthermore, web sites that sell “click-through” advertisements are often unspecialized. Therefore, an advertiser is competing with other advertisers from several different markets. For instance, if a potential customer enters the search term “French,” the advertising results from that search could include French fries, French food, French culture, French tourism, French revolution, and learn how to speak French.

Competing with advertisers from these varied markets has several disadvantages. First, bidding against a wide range of advertisers significantly increases the bid price for any single search term. For instance, an international fast food chain famous for its French fries can afford to bid much higher for the search term “French,” than a small company that sells French language tapes.

Second, even if a company can afford to monetarily compete and bid higher to obtain a higher position, the company likely does not attract a high ratio of serious potential customers per click-through. For example, if an advertiser's click-through advertisement is for French language tapes and is displayed along with advertisements for French fries or French food, an end user who is actually looking for a French restaurant, may, out of curiosity, uncertainty, or mistake, click-through to the French language web site, but not actually have any intention of buying French language tapes. Thus, the advertiser pays for a “click-through” to its web site that has a low probability of generating business.

Additionally, the reverse may be true. A potential customer searching for French language tapes may become distracted by the advertisement for French fries or French restaurants and click-through to those web sites instead of the one for French language. Thus, the distraction costs the advertiser a potential customer.

Furthermore, web sites that allow advertisers to maintain credit accounts for advertising costs generally only provide access for a single user. Therefore, one provider cannot have multiple users maintaining different aspects of the account. Only one user receives account notifications and only one user can update and modify the account. Since advertising accounts usually have several components, one user must be qualified and have security access to handle billing information, advertising material, and often programming code.

Finally, traditional internet advertising paradigms may not allow consumers the ability to compare one advertisement to another advertisement on the advertising host site. First, traditional advertising paradigms do not group related advertisements together into a single directory or source, making locating more than one advertisement for a given product difficult. Second, the consumer must click-through from one advertisement to that advertiser's home page and manually collect data, then the consumer must return to the advertising site and locate a second advertisement for a similar product or service and then repeat the process of clicking-through to that advertiser's web site and manually collecting data. Then the consumer must manually compare each collected data point. If the consumer fails to collect a data point needed for comparison or desires to compare again, the consumer must repeat the entire process. Repeating the process may be impossible as web site advertisements are often difficult to locate again.

Therefore, a need exists for a method of advertising on the Internet that does not require the advertiser to have its own web site, and yet provides for an advertiser to utilize a search term bid in a cost-effective manner while generating a high number of serious potential customers per bid amount paid.

### BRIEF DESCRIPTION OF THE DRAWINGS

FIG. 1 illustrates an embodiment of a system in which the method can be practiced;

FIG. 2 is a further illustration of the embodiment of a system in which the method can be practiced;

FIG. 3 is a flowchart illustrating the creation of a provider account;

FIG. 4 is a flowchart illustrating the initial setup of the provider account;

FIG. 5 is a flowchart illustrating the general account management features of the provider account;

FIG. 6 is a flowchart illustrating the account management features of the provider account based on type of provider;

FIG. 7 is a flowchart illustrating a promotions feature of the provider account;

FIG. 8 is a flowchart illustrating account summary and statistic summary features of the provider account;

FIG. 9 is a flowchart illustrating a report function of the provider account;

FIG. 10 is a flowchart illustrating functionality of a information tag maintenance tool;

FIG. 11 is a flowchart illustrating functionality of a search term maintenance tool;

FIG. 12 is a flowchart illustrating functionality of a ranking manager tool;

FIG. 13 is an example of the results of a keyword search in the ranking manager tool;

FIG. 14 is an example of information tags resulting from a directory search generated by one embodiment of the system; and

FIG. 15 is an example of on-site information accessible from a resultant information tag.

### DETAILED DESCRIPTION OF VARIOUS EMBODIMENTS

This description discloses a system and method for enabling an information provider to participate in an electronic directory and provide access to its information by selecting and bidding on search terms used to assist consumers in locating directory participants. The bid price is then used to rank identifying information tags, that when selected, charge the information provider its bid price to provide consumer access to the information providers' information that is maintained on the same web site as the directory.

Before preceding to a description of the figures, some preliminary connotational matters will be addressed. The term “host server” designates the server on which a “host web site” will be maintained. A host web site comprises one or more web pages, including, but not limited to, a provider home page, a consumer home page, an information tag web page, and an on-site information page.

The terms “host server” and “host web site” will be used interchangeably since in one embodiment, the host server is accessed through the Internet or World Wide Web, as a web site. Additionally, while it is recognized that there is a technological distinction between Internet and World Wide Web, the terms are seemingly interchangeably throughout this description. The use of these terms in this fashion is for descriptive convenience only. The skilled artisan will appreciate that the system encompasses the technological context of both the Internet and World Wide Web.

Therefore, “on-site information” refers to information provided on the same host web site or host server, albeit on a different or separate web page, as the provider home page, consumer home page, or information tag page. The term “information tag” includes, but is not limited to, a listing, a description, a banner, or a button. An information tag may be presented in any number of sensory formats, including, but not limited to, audio, visual, audio-visual, multimedia, and three-dimensional. A “search term” includes, but is not limited to, a keyword, a hot word, a search word or a “term.” Finally, a related group of information providers includes those providers who solicit consumers from a target market or specific market, such as education, healthcare, legal, and food.

In one embodiment, a web site host selects a specific market, such as education, and creates a web site with one or more web pages, designed to bring information and service providers in that market together with potential customers. The web site host then targets this specific market group of both information providers and consumers to access the host's web site. The host creates two different access vehicles for the host web site, one to be used by information and service providers, and the other by potential customers of those providers. The consumer accesses the host web site initially by searching the Internet for the specific market, for example, educational programs, and is directed to the host web site's educational program consumer homepage. The provider, however, accesses the host web site through a provider homepage.

The provider, through the provider homepage, creates a listing, or information tag, that provides the consumer with an initial description of the information the provider has on the host web site. The provider can increase visibility and access to its information by selecting keywords, or search terms, associated with the information tag and provider information. When a potential customer enters that search term, the information tag will appear as a listing with all other information tags from other information providers who have chosen the same search term.

The provider can further increase the visibility of its information tag by influencing the position of its information tag in the list. The provider influences the position of its information tag by bidding on one or more search terms associated with the information tag. The closer the provider is to the highest bid for a given search term, the higher the rank the information tag will receive, and thus the more desirable the position the information tag will have on the result or list returned for that search term.

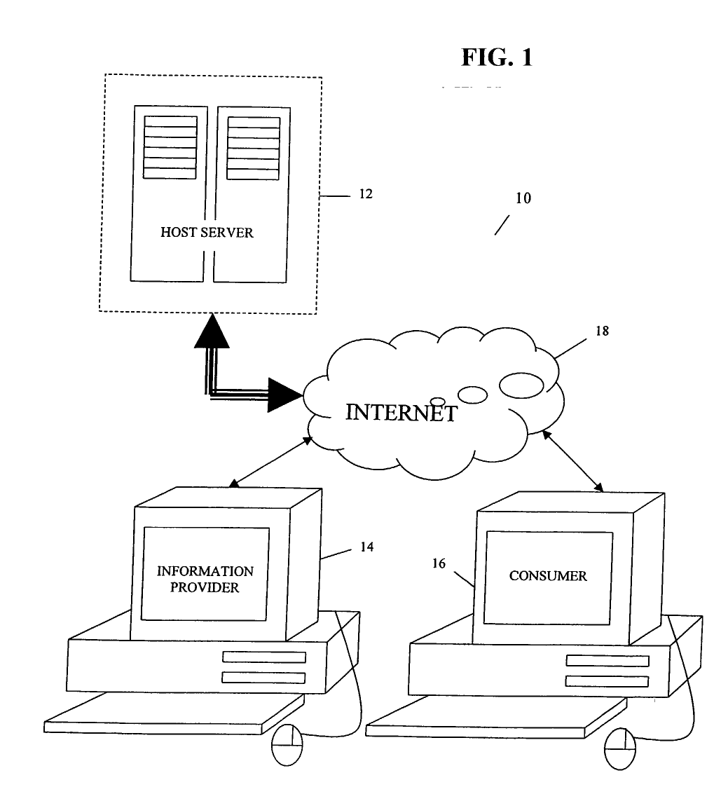

Turning now to the figures, FIG. 1 illustrates one embodiment of a system 10 for carrying out the invention. System 10 includes one or more host servers 12, one or more information provider computers 14, and one or more consumer computers 16, all communicating, via the Internet 18, using standard generally known data exchange techniques, such as the TCP/IP protocol.

The host server 12 includes a host web site stored in unillustrated memory, with the web site including one or more web pages. More specially, the web pages are formatted and developed using Hyper Text Markup Language (HTML) code. As is known in the art, an HTML web page included both “content” and “markup” portions. The content portion is information that describes a web page's text or other information for display or playback on either information provider computer 14 or consumer computer 16 via a display screen, audio device, DVD device, or other multi-media device. The markup portion is information that describes the web page's behavioral characteristics, including, how the content is to be displayed (e.g., the frame set), and how other information can be accessed (e.g., “hyperlinks”). Thus, the HTML code that marks up formatted web pages of the host web site of one described embodiment includes markup portions that cause web pages to be displayed in selected, predetermined display regions of a single computer display screen. It is appreciated that other languages, such as SMGL (“Standard Generalized Markup Language”), XML (“Extensible Markup Language”), DHTML (“Dynamic Hyper Text Markup Language”), Java, Flash, Quick Time, or any other language for implementing web pages could also be used.

The information provider computer 14 and consumer computer 16 are any type of computing device capable of accessing host server 12 through a host web site via the Internet 18, and capable of displaying host server's 12 stored web pages using well known web browser software packages, or any other web browser software. Such computing devices include, but not limited to, personal computers (PCs), both IBM-compatible and MacIntosh; hand-held computing devices (e.g., PDA's), cellular telephone devices, and web-based television sets (e.g., “Web-TV”), so long as information provider computer 14 and consumer computer 16 includes a properly driven display.

Host server 12 is any type of computer server capable of supporting a web site and web-based management tool. The operating system used to run host server 12 and programming used in implementing the method of one embodiment are stored in unillustrated memory resident with host server 12. The operating system and stored programming used in implementing the method of one embodiment can be any operating system or programming language.

The various hardware and software components of system 10 communicate via Internet 18 to implement the method of the present invention. Although not depicted, Internet 18 access by information provider computer 14 could be implemented via an Internet Service Provider (ISP), a direct dial-up modem connection, a digital subscriber link (DSL), a dedicated T-1 connection, or any other communication link.

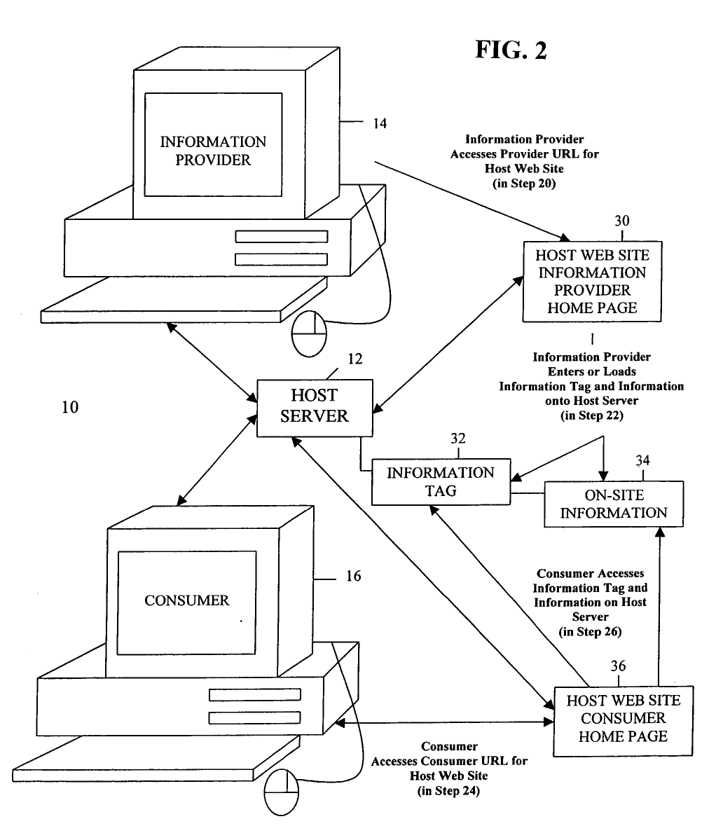

Turning now to FIG. 2, when information provider computer 14, running any of several web browser software packages, accesses the Internet, an information provider is able to access an information provider home page 30 of a host web site stored on host server 12 through accessing the Provider URL (Uniform Resource Locator) in step 20. URL access may occur by numerous and varied methods. By way of example, the information provider may type the desired URL directly into the browser. In addition, the information provider may access the URL by selecting a hyperlink displayed on another web site or web page that links information provider computer 14 to the information provider homepage 30 via step 20. Hyperlinks displayed on a web page transfer information provider computer 14 to a different web site or web page when selected by the information provider. The hyperlink to the information provider home page 30 may be included as part of an e-mail message displayed by information provider computer 14. In either of these examples, when the information provider selects the hyperlink, information provider computer 14 is directed in step 20 to the information provider home page 30. Information provider home page 30 is then displayed on the display screen of information provider computer 14. Once directed in information provider home page 30, the information provider can, in step 22, enter or download on to host server 12, one or more information tags 32 and/or on-site information 34, as described in detail below, as well as carry out all other details of the method illustrated and described below.

Also, according to one embodiment of the method illustrated in FIG. 2, a consumer computer 16 can likewise access a consumer home page 36 on the host web site stored on host server 12, via the Internet, by accessing the consumer URL for the host web site in step 24. Accessing the consumer URL can occur by any means possible, including the examples described above. When the consumer selects the consumer URL hyperlink, consumer computer 16 is directed, in step 26 to the consumer home page 36. Consumer home page 30 is then displayed on the display screen of consumer computer 16. Once directed to consumer home page 30, the consumer can, in step 26, access, through the host web site, information tag 32 and on-site information 34 stored on host server 12, and as previously provided by information provider computer 14, as described below in the details of the method.

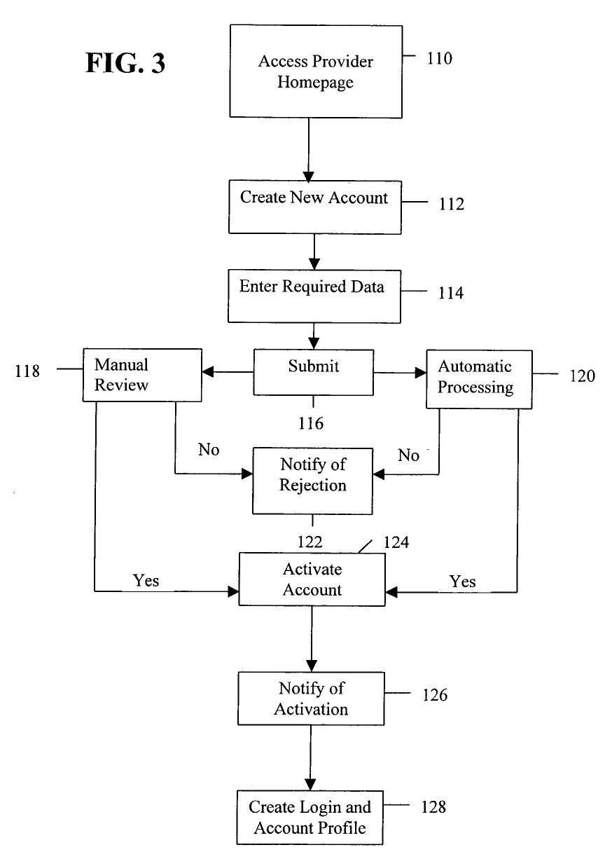

In FIG. 3, an information provider accesses a provider homepage in step 100. In step 112, a new information provider creates a new account by selecting new account setup and following the instructions on how to create a new account. For a new account, in step 114, the information provider enters required data, for example, company name, address, email, and phone number. Additional information may be required including, but not limited to, billing contact information and other additional contact information if multiple contacts are required for the account.

Once this data is submitted in step 116, the data will either be manually reviewed by the host in step 118 or automatically checked and processed in step 120. If the review or processing return a rejection for the new account in step 120, the information provider will be notified of the rejection, in step 122. Following successful review and processing, in step 120, the new account will be activated by the host in step 124, and the information provider will be notified of the activation in step 126. The information provider can then, in step 128, create a login and account profile.

The provider homepage may also contain links to or information on the benefits of having the provider's information on the host web site. Additionally, further instructions and details of how the host web site provides access to potential customers and maintains the provider's information may also be accessible from or on the provider homepage.

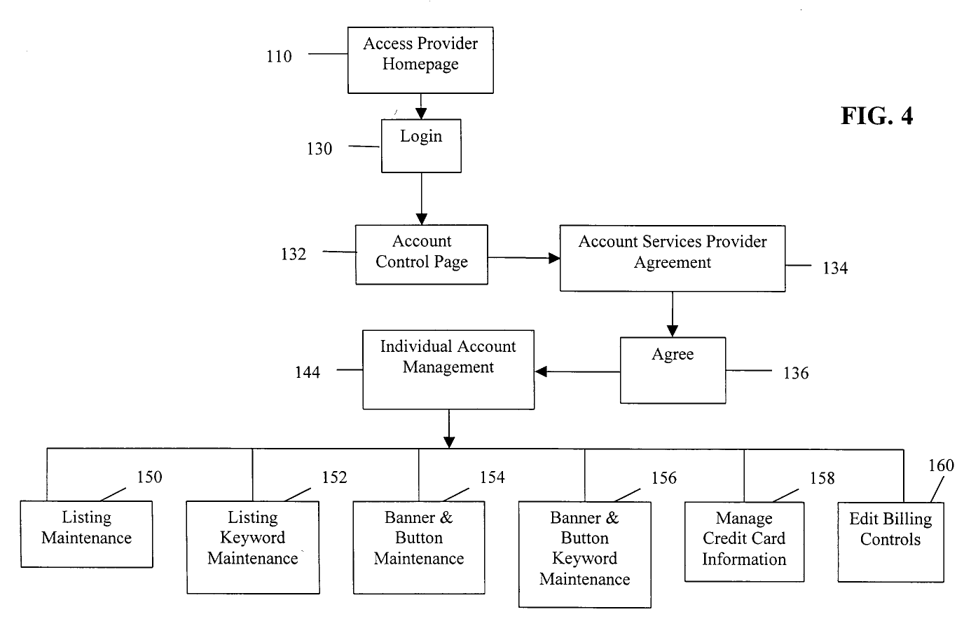

In FIG. 4, an information provider with an existing account accesses the provider homepage in step 110. In step 130, the information provider logs into the host web site and is directed to the provider's account control page, in step 132. The first time a provider logs into the account control page, an account services provider agreement page is displayed in step 134. In order to proceed, the provider must select “agree” in step 136 and agree to the stipulations of the account services provider agreement. The account services agreement page includes any type of terms and conditions of use normally used by host web sites.

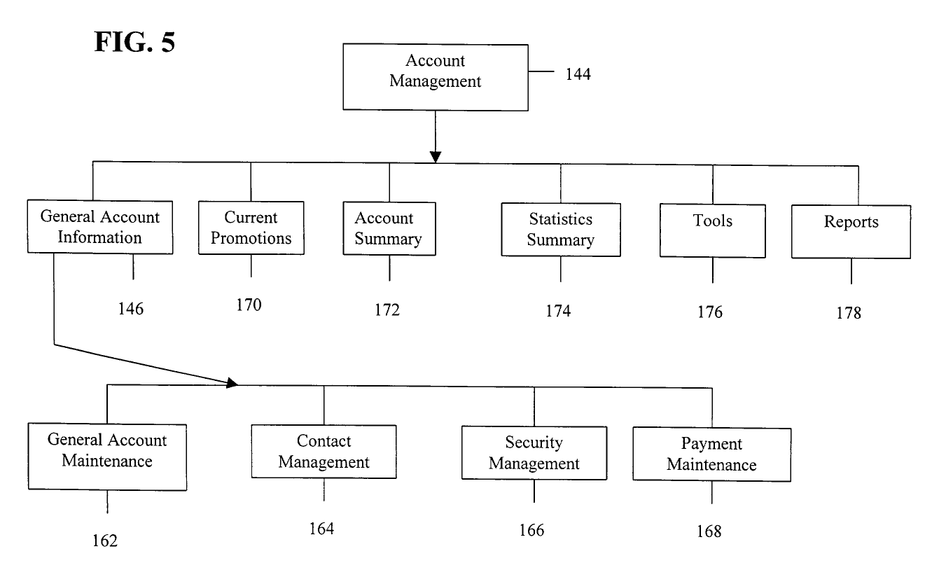

In FIG. 5, the provider enters the account management page in step 144. The provider can then, in step 146, add and edit general account information previously entered in the account profile. General account information includes, but is not limited to, general account maintenance 162, contact maintenance 164, security maintenance 166, and payment maintenance 168. The provider can also view current promotions in step 170, view account summary in step 172, view statistics summary in step 174, use provider tools in step 176, and create, run and view reports in step 178. In general account maintenance 162, the provider will have the ability to review and modify any existing general company information.

One embodiment envisions multiple users for each information provider account. In step 164, the provider has entered contact maintenance. In contact maintenance 164, the provider can then add, edit, activate, inactivate or reactivate all contacts. Contacts in contact maintenance 164 include a master contact, billing contacts, company contacts, security contacts and advertisement contacts. According to one embodiment, access may be parceled by contact status. For instance, a provider logged on as a master contact may have access to all facets of account maintenance, including contact management 164, security management 66, and payment maintenance 168. However, a provider logged on as a company contact would only have access to general account maintenance 162.

Parceled account access has several advantages. First, multiple users for one provider can access the provider account to edit and modify specific account functions and parameters. For example, a billing contact with secure access to company credit cards, invoices, and other billing statements would have access to at least payment maintenance. An advertisement contact, however, would not have access to billing controls in payment maintenance, but would still be able to access the provider account and update the information tag and on-site information. Parceled access provides increased security and flexibility for information provider account holders.

In addition to parceled access, multiple user access allows the provider to have multiple users receive notifications from the web site host. Therefore, no longer will the provider need to rely on a single account manager. Each user with an email address entered in contact information will receive designated emails depending on access level or status regarding, for example, account maintenance, payment maintenance, outbid notices, and other email notifications.

In security management 166, the provider will have the ability to set up or modify the security profile. Preferably, the master contact or billing contact will have access to security management 166. Set up or modification allows the provider to activate or inactivate available features for every contact. The provider may change security by enabling or disabling a given contact. The provider may also delete a particular contact. For individual contacts, the provider may also change the range of access to options on the account control page. Options available for contact access include, but are not limited to, listing maintenance 150, listing keyword maintenance 152, banner and button maintenance 154, banner and button keyword maintenance 156, manage credit card information 158, and edit billing controls 160, shown in FIG. 4. Each option that the provider enables becomes part of the provider's individualized account management page, in step 144.

In payment maintenance 168, the provider is allowed to enter and modify payment information including managing credit card information 158, and editing billing controls 160. One embodiment envisions that managing credit card information 158 will typically comprise credit card information, debit card information, or automatic withdrawal information. Ideally, the provider will have multiple credit cards or bank accounts on file in the system from which to extract payment. Although the provider would keep multiple credit cards or accounts on file, the provider could, through payment maintenance 168, activate or inactivate specific credit cards or accounts from the list, or in the alternative, add and delete additional credit cards and accounts.

In addition to editing billing controls 160, the provider will also be able to view the minimum required balance. In order to be considered an active account, an account must have a current balance above the minimum required balance and a recharge amount, as well as credit card information. The minimum required balance is used to control the automated billing process. At any time the account balance reaches the minimum required balance, a new charge equaling the recharge amount will be processed.

Each account will be assigned a minimum required balance. Every account will first be assigned the default minimum required balance when the account is initially created. However, the minimum required balance may be changed manually by the web site host or automatically based upon usage, average monthly invoice, payment history, or other criteria. Additionally, each account will be assigned a minimum recharge amount. In payment maintenance 168, the provider can modify the recharge amount, but the amount entered must be greater than or equal to the minimum recharge amount.

Additionally, in payment maintenance 168, the provider will be able to enter a maximum bid price that can be placed on any keyword. If the provider changes the limit and any existing information tags have bids that exceed the new limit, the information provider will be notified that all bids exceeding the limit will be reduced to the newly entered limit amount. The provider will then be required to approve the reduction or cancel the new lower limit. The same scheme may also be applied to each information tag. The provider may set a spending limit total for each information tag. Additionally, this limit may be based upon a predetermined time period.

The features of payment maintenance 168 explained above are used in the payment maintenance budgeting function. Budgeting allows the provider to set and control spending limits by developing and entering a budgeting structure. The budgeting structure allows a provider to allocate monetary resources to be spent for each information tag and for each keyword. For instance, a provider has ten keywords for one information tag, each with a maximum bid price of one dollar per display of the information provider's on-site information, also “ad display” in one embodiment. However, the provider does not want to spend over one hundred dollars per day on providing access to its on-site information. Therefore, the budgeting function will contain a summing algorithm which continuously sums the cost per ad display for all ten keywords for the one listing. Once that total within a twenty-four hour period reaches one hundred dollars, the maximum bid price for each of the ten keywords will automatically be set to zero. Once the twenty-four period resets, the maximum bid price for each of the ten keywords will also reset to one dollar, and the budget calculator will reset to zero. One embodiment also envisions other types of budgeting mechanisms that allow a provider to limit spending and allocate resources among keywords and information tags.

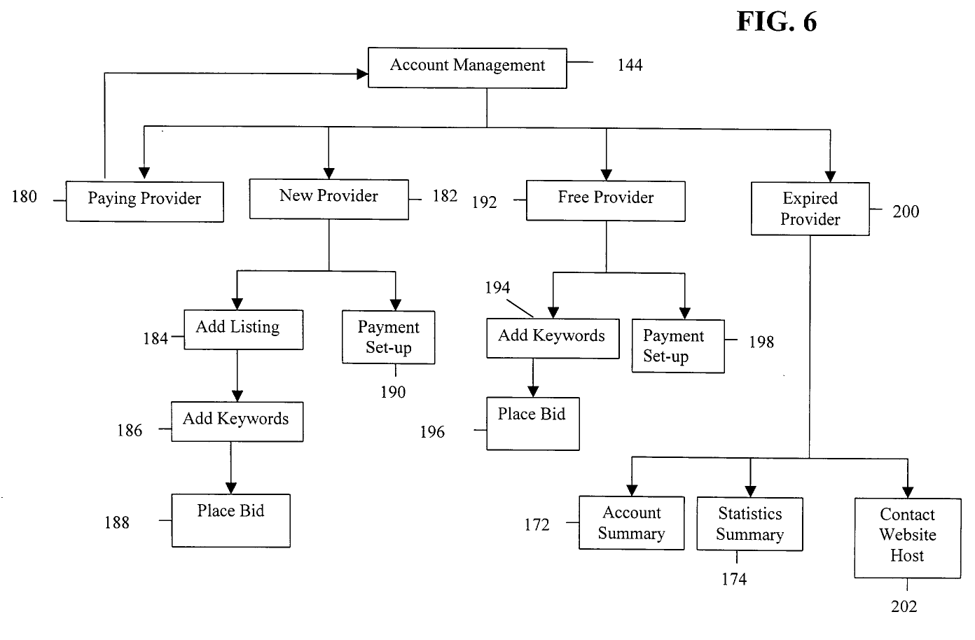

If the provider is an existing paying provider in step 144 as shown in FIG. 6, the provider will, in step 180, access the standard account management page, as illustrated in FIG. 5. If the provider has a new account and no listings have been entered, then the provider is a new provider in step 144, and the provider will enter the new provider page in step 182. The new provider page comprises a welcome statement and step-by-step instructions on how to get started. From the new provider page, in step 182, the provider can then add a listing in step 184, followed by adding keywords in step 186, and the placing a bid in step 188. The new provider can also setup payment in step 190.

If the provider has not entered payment information and the account balance is zero, the provider is a free provider in step 144, and the provider will enter the free provider page in step 192. The free provider page comprises a marketing message to encourage the provider to improve the performance of its information tag or listing by adding keywords and placing bids on those keywords. Therefore, from the free provider page, the provider can add keywords in step 194 and then place a bid in step 196. The provider can also access payment setup in step 198.

If the provider in step 144 has an account balance that is below the minimum requirements to maintain an account, or the account has expired due to declined charges, or an expired or inactive credit card, the provider is redirected to the expired provider page in step 200. The provider is notified, preferably in a bold red or other attention-getting manner, that the account has expired. The expired provider can either view account summary, step 172, view statistics summary, step 174, or in step 202, the provider can contact the host to resolve the problem, remit payment, or re-apply for account activation.

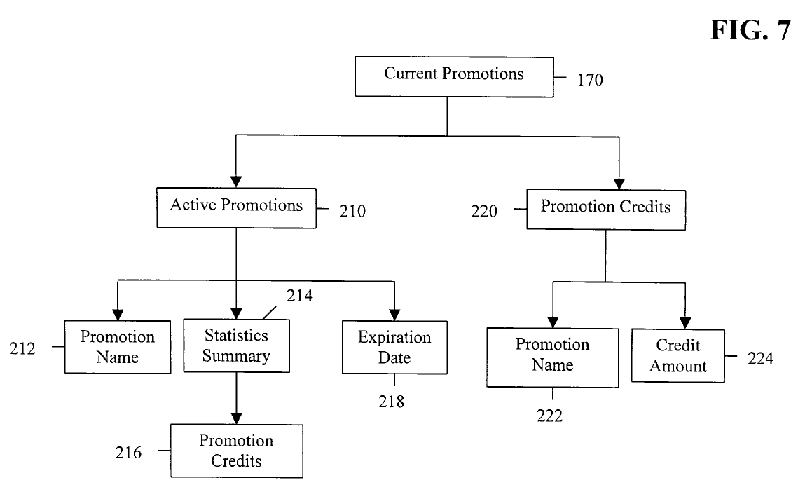

As illustrated in FIG. 7, when a provider enters the current promotions page in step 170, the provider can view active promotions in step 210. The active promotions comprises a promotion name 212, a description 214, including promotion credits available for that promotion 216, and the expiration date 218 for the promotion. The provider can also view the promotion credits 220 by promotion name 222, that the provider has already earned, and the credit amount 224, preferably over the last thirty-day period.

One embodiment envisions that promotions may be granted globally to all providers or to select providers as determined by the host web site based on a variety of criteria. Providers may be individually notified of a special promotion and may be required to enter a user code in step 210 to view the active promotion. It is also envisioned that the host creates promotion templates to re-use for new promotions. Standard templates include, but are not limited to, one-time promotions, new account promotions, new advertisement promotions, and new keyword promotions.

All promotions are given specific values that are displayed on the account control page when a user logs in and selects current promotions in step 170. Promotions may be granted automatically or may be selectively granted based on certain criteria. Such criteria include logging in as a new provider, adding new listings, or reaching specified revenue goals. Whenever a promotion is granted to a provider or a provider enters a promotion code, that information is stored for that particular provider along with promotion name 222 and credit amount 224. The credit amount 224 is then reflected on the provider's balance.

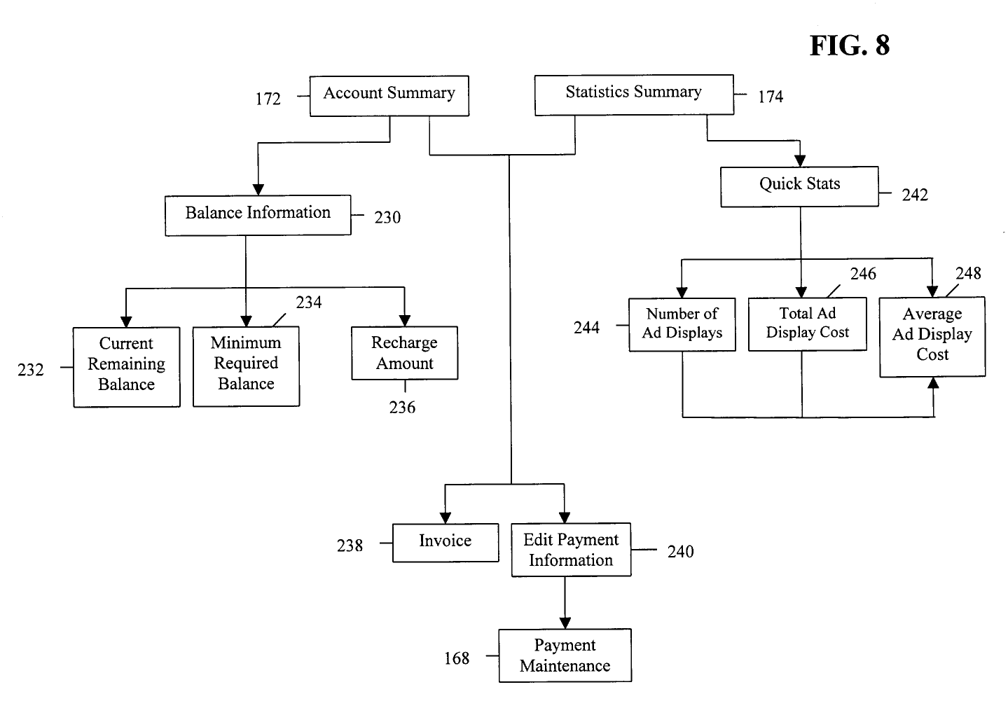

As shown in FIG. 8, when a provider enters the account summary page in step 172, the provider views, in step 230, balance information. Balance information includes the current remaining balance 232 in the provider's account and the minimum required balance 234 needed to maintain an active account. The provider can also enter a recharge amount 236 that is then processed and added to the current remaining balance 232. Recharge amount 236 is the amount the provider selects to be charged at anytime the minimum required balance is reached. A minimum recharge amount 236 will be assigned to every provider. The provider must enter a recharge amount 236 greater than this minimum.

The provider may also view and print a current invoice in step 238 and edit payment information in step 240. If the provider chooses to edit payment information in step 240, the provider will be directed to payment maintenance 168. Once in payment management, the provider may view the minimum required balance 234 and edit the minimum recharge amount 236.

In FIG. 8, the provider can also enter the statistics summary page in step 174. The provider views, in step 242, the quick stats collected by the host web site for the provider's account. Quick stats include, for example, the number of ad displays 244 for the current month to date and total ad display costs 246 for the current month to date. Using number of ad displays 244 and total ad display costs 246, the average ad display charge 248 for the current month to date is calculated and displayed. From statistics summary in step 174, the provider can also view and print a current invoice in step 238 and edit payment information in step 240. If the provider chooses to edit payment information in step 240, the provider will be directed to payment maintenance 168.

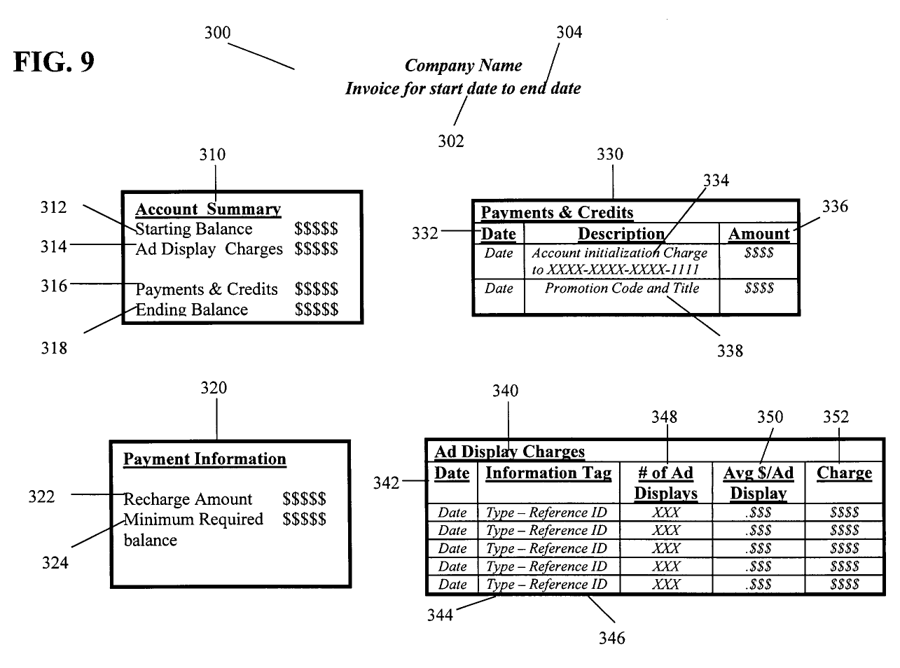

FIG. 9 illustrates the reports function of one embodiment. A reports menu will be available for the reports. Several different reports will be available for the provider to run. For example, current and historical billing invoice reports can be generated. Invoice 300 comprises four separate reports: account summary 310, payment information 320, payments and credits 330, and ad display charges 340. The current invoice will default to run for the current month to date; however, the provider is able to modify the starting time for the current invoice, but not the end time, as that will be set at the current date. If a provider desires to run an invoice not ending on the current date, the provider will run a historical invoice report. The historical invoice report will allow the user to specify any starting to ending date range and view all account history.

The provider will also be able to run individual reports, for example, account summary 310. An account summary report 310 has several features. Starting balance 312 reflects the account balance for the start date 302 of the report. Ad display charges 314 reflect the total amount for ad display charges deducted from the account balance for the specified time period designed by the start date 302 through end date 304 of the report. Payments and credits 316 reflect the sum of all credit card charges and any promotion credits 216 for the account for the specified time period designated by start date 302 and end date 304. Ending balance 318 reflects the balance of the account for the end date 304 of the report.

Payment information report 320 will display the minimum required balance 324 and the current recharge amount 322 for informational purposes. Payments and credits report 330 is capable of displaying all credits applied to the account. The first category of credits are payments or credit card charges. Payments or credit card charges will be displayed with the date 332 of the payment, description of the charge type 334, and amount 336 of the charge. Charge types 334 include account initialization, re-charge, or re-initialization. Promotion credits will be summarized by date 332 promotion credit was received, promotion code and title 338, and amount 336 of credit.

Finally, daily ad display charges may be displayed in ad display charge report 340. Daily charges are capable of being summarized by information tag, keyword, or a combination of the two. For example, if a provider has one keyword for multiple information tags, the report can break down daily ad display charges by keyword and then again by information tag. If a provider has one information tag with several keywords associated with the information tag, then the report can break down daily ad display charges by information tag first, then by each individual keyword.

Ad display charge report 340 comprises the date 342, the information tag type 344 or keyword, and reference identification number 346. The report also displays the number of ad displays 348 for date 342, the average ad display charge 350, and the total amount of ad display charges 352 for the information tag or keyword for date 342.

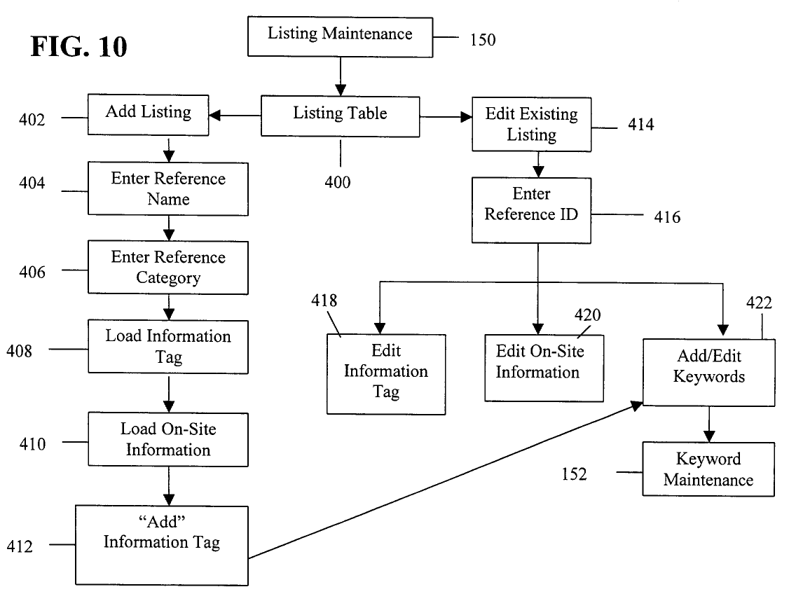

FIG. 10 illustrates how an information provider creates and edits both its on-site information and its information tags. According to the depicted embodiment, a listing comprises an information tag and its associated on-site information. In step 150, the information provider accesses the listing maintenance page to add a new listing or edit an existing listing. After entering the listing maintenance page, the provider views its listing table in step 400. If the provider wants to add a listing in step 402, the provider enters the reference name in step 404 into the first blank row of the listing table. The provider also enters a reference category for the listing in step 406. The provider will select a category from a drop-down box of pre-determined category labels. Reference categories assist the provider in grouping and organizing its listing. Once the provider assigns a reference name and category, the provider can then enter or load the information tag for that listing in step 408. In step 410, the provider can then enter or load the on-site information associated with the information tag. Finally, the provider selects “add” in step 412 and the new listing is assigned a reference identification number and loaded into the system. Next, the provider must select add/edit keywords in step 422 to access keyword maintenance 152 to select and bid on search terms to associate with the new listing. If the provider wants to edit an existing listing in step 414, the provider enters the listing's reference identification number in step 416 to recall the existing listing. The provider can then edit the information tag in step 418 either manually or by loading a new information tag into the system for that reference identification number. The provider can also edit the on-site information in step 420 in the same manner. If the provider wants to add or edit the associated keywords in step 422, the provider will be directed to keyword maintenance.

Once a listing has been added or edited, the provider has the option of copying the entire listing, the information tag, or the on-site information into another listing category. Therefore, if one listing was appropriate for two different categories, the provider does not have to duplicate effort.

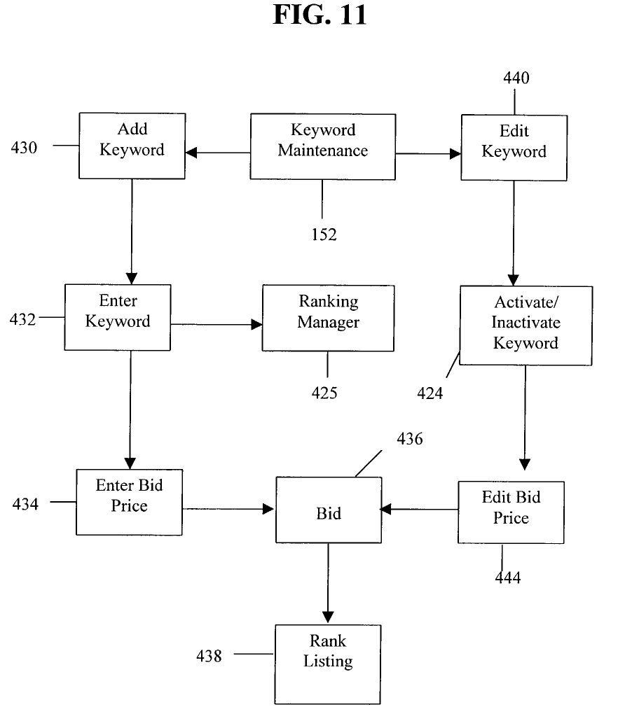

As shown in FIG. 11, the information provider accesses keyword maintenance 152. Keyword maintenance provides one functional mechanism for auctioning a search term to an information provider. If the provider is adding a keyword in step 430, the provider enters the new keyword or search term in step 432. A search term may comprise any word or words totaling fifty characters in length. In step 434, the provider enters a bid price for the search term. If no other listings have bid on the entered search term, the provider may enter the minimum established bid for the listing category. The provider will then, in step 436, be ranked first. However, if the search term has received previous bids, the provider can access ranking manager in step 450 to determine the resulting rank in step 438 from entering a particular bid in step 434.

If the provider desires to edit a keyword in step 440, the provider can modify existing keywords. In step 442, the provider can also inactivate existing keywords for the listing. If a keyword had been previously inactivated, the user can also re-activate that keyword in step 442. For existing activated keywords, the provider can modify a previously entered bid amount in step 444. If a provider wants to view the existing bids for the keyword, the provider can access the ranking manager.

Once the provider has determined its desired bid amount, the provider participates in the auction for the search term by entering the amount in step 444. The provider then bids that amount in step 436 and the listing is ranked accordingly to that bid amount in step 436. The provider's information tag is then displayed based on the bid amount from the auction.

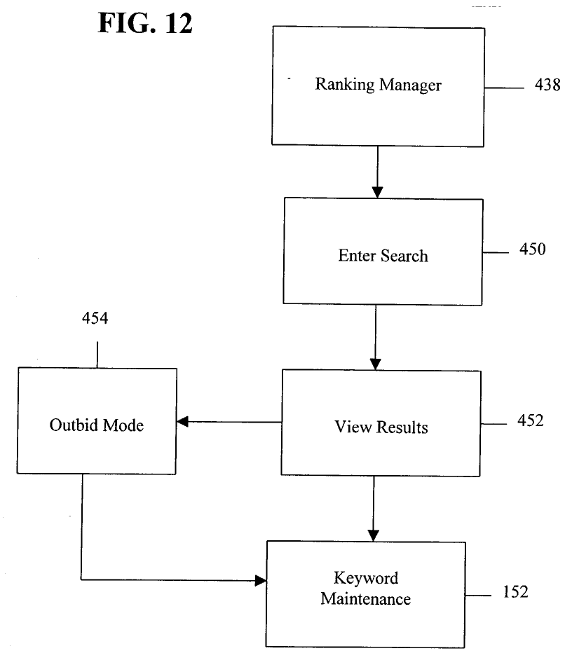

FIG. 12 illustrates the ranking manager feature of one embodiment. When a provider selects ranking manager in step 450, the provider can view existing listings with existing bids on a desired search term. In step 452, the provider enters a desired keyword and searches existing listings. In step 454, the results of the search are displayed. The results lists the information tags associated with the desired search in ranked ordered based on bid amount. The bid amount is also listed in parentheses next to the information tag.

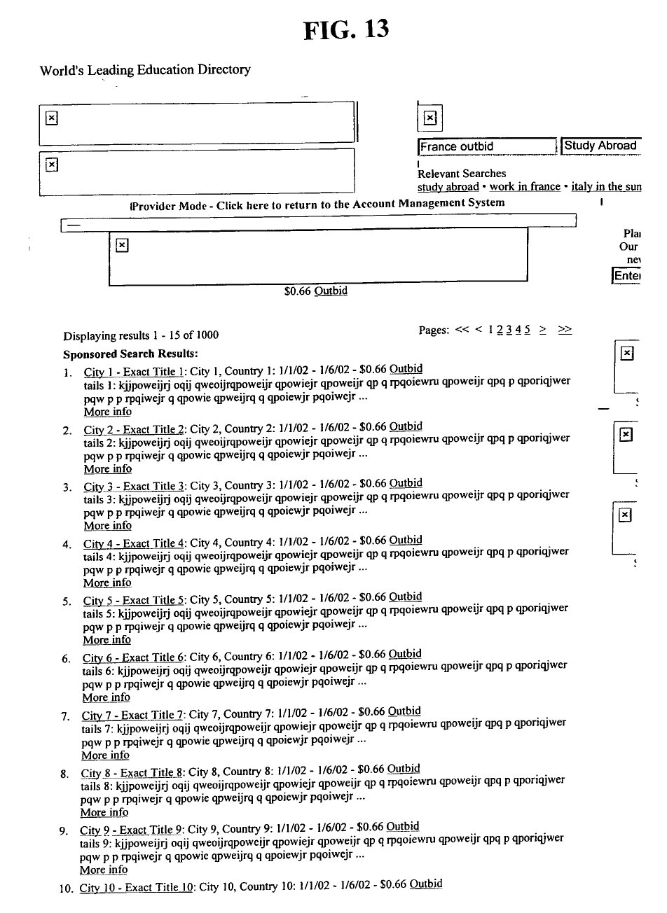

FIG. 13 is an example of the results returned for a keyword search for the term “city” in ranking manager. The minimum bid for a position is $0.66. To obtain the highest rank for a new listing, the provider would need to bid at least $0.67 on the search term “city”. However, a bid of $0.66 would place the listing at the number two position. Based on this information, the provider can then strategically bid on the search term to maximize rank position based on bid amount. Thus, the provider returns to keyword maintenance in step 456 to enter a bid amount and participate in the auction for the search term.

An additional feature of one embodiment is outbid mode. The provided selects “outbid” next to its information tag and bid price. Outbid mode allows a provider to retain a certain rank or position for a given search term. If the information provider selects “outbid mode” in keyword maintenance 152, the information provider will be given additional options or parameters for setting up outbid mode. Parameters include, but are not limited to, rank, cost per ad display, and total cost. If the information provider selects rank, the provider enters the position number that the provider wants to retain for its information tag. For example, if the information provider desires to retain the number one position, the information provider enters the number one. This will set the information provider's account to automatically outbid any other information provider, so that the first information provider retains the number one position.

However, if the information provider wants to be in the number one position, but not pay over one dollar per ad display for that position, the information provider would enter one dollar as the maximum per ad display amount. Now, another information provider could obtain the number one position for $1.01, but the first information provider would automatically outbid all other bidders up to one dollar. Finally, the total cost function allows the information provider to input a total cost for a given keyword. The information provider would then retain the number one position by automatically outbidding other information providers, until the total cost of retaining the number one position has reached the threshold dollar amount entered by the information provider as the total cost.

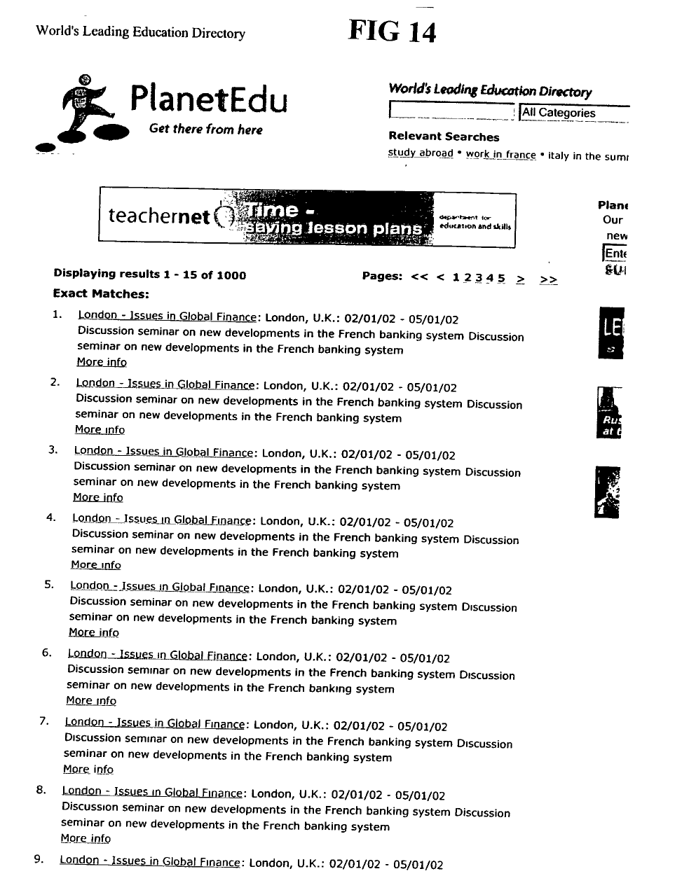

FIG. 14 illustrates the resulting information tags as viewed by a potential consumer. The highest ranked listing is attributable to the highest bidder for the listing category of the search term “London.” The ranking of listings continues in order of bid amount for the search term. Additionally, “teachemet” had the highest bid for the banner category of information tags for the search term “London.” Thus, teachernet appears as the top banner and is ranked first in time, and thus appears first when the search results are generated. The second highest bidder for the banner category would be second in the temporal rotation of the head banner.

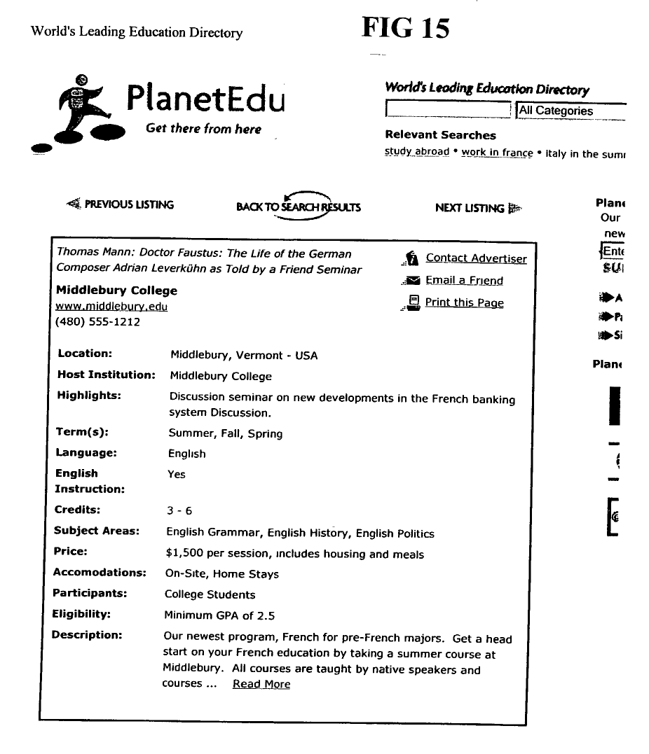

Once a potential customer selects an information tag from FIG. 14, the consumer is then allowed access to the information provider's on-site information in FIG. 15. FIG. 15 represents one of several different formats of on-site information envisioned by one embodiment. On-site information may be presented in a number of formats including visual, audio, audio-visual, multimedia and three-dimensional.

Once a consumer selects an information tag, the information provider for that information tag is charged its bid price for the web site host allowing the consumer access to the on-site information in FIG. 15. Additionally, once a consumer accesses the on-site information, the web site host provides the consumer with the option of comparing one or more of the displayed data points in the on-site information with one or more additional resultant information providers for the search. The web site host also allows the consumer to save the comparisons under a user profile for future access and future additional comparisons and analysis.

The depicted embodiment envisions a method of facilitating comparison shopping by consumers that utilizes numerous data points, including, but not limited to, consumer satisfaction ratings, best value, industry ratings, and cost. The web site host will provide consumer comparison tools known in the art on its site. This invention also envisions a method of facilitating consumer product and service selection. The web site host will provide tools known in the art for sorting and filtering the on-site information using one or more data points selected by the consumer. As with the consumer comparisons, the results of the consumer's sorting and filtering can also be saved in a user profile. Both these host-facilitated shopping methods can be used alone or in combination.

The depicted embodiment further envisions that the web site host will also provide tools known in the art for consumers to purchase products from the information providers based on the on-site information provided to the consumer. Additionally, consumers will be able to apply for services on the host web site that are offered by the information providers through the on-site information provided.

Various embodiments of the invention are described above in the Drawings and Description of Various Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated. Therefore, it is intended that the invention not be limited to the particular embodiments disclosed for carrying out this invention, but that the invention will include all embodiments falling within the scope of the appended claims.

What is claimed is:

1. A method of influencing position tags allowing access to on-site information, comprising:
auctioning a term to an information provider;
ranking an information tag for the search term based on a bid amount from the auction;
displaying the information tag; and
allowing access to on-site information associated with the information tag.

2. The method of claim 1, further comprising targeting a related group of information providers.

3. The method of claim 1, wherein the information provider is advertising a product or service.

4. The method of claim 1, further comprising allowing a consumer access to the on-site information.

5. The method of claim 4, further comprising providing a mechanism for the consumer to compare a first data point of the on-site information with a second data point from a second information source.

6. The method of claim 4, further comprising providing a mechanism for the consumer to sort the on-site information based on a data point associated with onsite information.

7. The method of claim 4, further comprising providing a mechanism for the consumer to select on-site information based on a data point associated with the on-site information.

8. The method of claim 4, further comprising allowing the consumer to create a user profile.

9. The method of claim 4, further comprising allowing the consumer to save the on-site information accessed in the user profile.

10. The method in claim 4, further comprising allowing the consumer to provide data to the information provider.

11. The method of claim 1, further comprising ranking and displaying the information tag in a spatial orientation.

12. The method of claim 1, further comprising ranking and displaying the information tag in a temporal orientation.

13. The method of claim 1, wherein displaying the information tag includes a multimedia display.

14. The method of claim 1, wherein displaying the information tag includes an audio sound bite.

15. A system for influencing position of information tags allowing access to on-site information, comprising:
a host server computer including a web site having one or more content-based web pages and in communication with one or more distribution mediums,
wherein, in response to a communication from a provider computer, said host server computer directs said provider computer to bid on a search term, and said host server displays an information tag for the search term based on a bid amount from the auction, wherein said information tag allows access to on-site information associated with the information tag.

16. The system in claim 15, further comprising a consumer computer in communication with one or more distribution mediums,
wherein, the host server computer in response to a communication from the consumer computer directs said consumer computer to search a directory for the information tag.

17. The system in claim 16, wherein the information tag allows said consumer computer to access the on-site information.

18. A computer-readable storage medium containing computer executable code for instructing a server computer to perform the steps of:
auctioning a search term to one or more information providers;
ranking and displaying an information tag for the search term based on a bid amount from the auction; and
allowing access to on-site information associated with the information tag.

19. The computer-readable storage medium in claim 18, further containing computer executable code for instructing a server computer to perform the step of allowing a consumer computer to access the on-site information associated with the information tag.

20. A method of managing web-based advertising accounts, comprising:
allowing an information provider to create a web-based advertising account;
providing first and second account features to the information provider;
parceling access to the first and second account features, wherein a first user is capable of accessing the first account feature and a second user is capable of accessing the second account feature.

21. The method in claim 20, further comprising allowing the first and second users to enter contact information.

22. The method in claim 20, further comprising allowing the first user to enter an information tag.

23. The method in claim 20, further comprising allowing the first user to enter on-site information.

24. The method in claim 20, further comprising allowing the first user to bid on a search term.

25. The method in claim 24, further comprising allowing the first user to associate the search term with an information tag.

26. The method in claim 20, further comprising allowing the second user to enter billing information.
